(19) United States
(12) Patent Application Publication
(10) Pub. No.: US 2015/0205796 A1
(43) Pub. Date: Jul. 23, 2015

(54) INFORMATION PROCESSING DEVICE, INFORMATION PROCESSING METHOD, AND PROGRAM

(71) Applicant: SONY CORPORATION, Tokyo (JP)

(72) Inventors: Kazunori ARAKI, Kanagawa (JP); Shinobu KURIYA, Kanagawa (JP); Masanori MIYAHARA, Tokyo (JP)

(21) Appl. No.: 14/590,357

(22) Filed: Jan. 6, 2015

(30) Foreign Application Priority Data
Jan. 17, 2014 (JP) 2014-006739

(51) Int. Cl. G06F 17/30

(52) U.S. Cl. CPC G06F 17/3053

(57) ABSTRACT

There is provided an information processing device including a log acquisition unit configured to acquire an activity log of a user for content, an attribute estimation unit configured to estimate an attribute of the user for the content on the basis of the activity log, and a score calculation unit configured to calculate a score on the content on the basis of the activity log and the attribute.

### CROSS REFERENCE TO RELATED APPLICATIONS

This application claims the benefit of Japanese Priority Patent Application JP 2014-006739 filed Jan. 17, 2014, the entire contents of which are incorporated herein by reference.

### BACKGROUND

The present disclosure relates to an information processing device, an information processing method, and a program.

Collecting feedback information of a user for content has been already widespread. For example, JP 2009-009184A describes a technology of acquiring an operation or expression of a user for content as feedback information and learning a preference of the user for the content on the basis of the acquired feedback information.

### SUMMARY

However, for example, in a case where feedback information is collected from many users and a ranking of content is made on the basis of the collected feedback information by using the technology such as described in JP 2009-009184A, all feedback from the users are treated equally. Accordingly, a desired result may not be obtained. This is because attributes are not considered when the ranking or the like is generated on the basis of the feedback information, the attributes indicating whether a user is interested in content, or whether the user is familiar with the genre to which the content belongs, for example.

Accordingly, the present disclosure proposes a novel and improved information processing device, information processing method and program capable of rating content more in line with an actual condition, by considering an attribute of a user for content.

According to an embodiment of the present disclosure, there is provided an information processing device including a log acquisition unit configured to acquire an activity log of a user for content, an attribute estimation unit configured to estimate an attribute of the user for the content on the basis of the activity log, and a score calculation unit configured to calculate a score on the content on the basis of the activity log and the attribute.

According to another embodiment of the present disclosure, there is provided an information processing method including acquiring an activity log of a user for content, estimating an attribute of the user for the content on the basis of the activity log, and calculating, by a processor, a score on the content on the basis of the activity log and the attribute.

According to another embodiment of the present disclosure, there is provided a program for causing a computer to achieve a function of acquiring an activity log of a user for content, a function of estimating an attribute of the user for the content on the basis of the activity log, and a function of calculating a score on the content on the basis of the activity log and the attribute.

As explained above, one or more of the embodiments of the present disclosure is capable of rating content more in line with an actual condition, by considering an attribute of a user for content. Note that the present disclosure is not limited to the effect stated above and in addition to or in place of the effect stated above, may achieve any of the effects indicated in this specification or effects that can be understood from the specification.

### BRIEF DESCRIPTION OF THE DRAWINGS

FIG. 1 is a diagram showing a system configuration according to an embodiment of the present disclosure;

FIG. 2 is a block diagram schematically showing functional configurations of a server according to an embodiment of the present disclosure;

FIG. 3 is a diagram illustrating calculation of a score for each temporal position of content according to an embodiment of the present disclosure;

FIG. 4 is a diagram illustrating propagation of feedback according to an embodiment of the present disclosure;

FIG. 5 is a diagram showing an example of output of a result according to an embodiment of the present disclosure;

FIG. 6 is a diagram showing an example of output of a result according to an embodiment of the present disclosure;

FIG. 7 is a diagram showing an example of an activity log DB according to an embodiment of the present disclosure;

FIG. 8 is a diagram showing an example of scores on contents for each user according to an embodiment of the present disclosure;

FIG. 9 is a flowchart showing an example of processing according to an embodiment of the present disclosure; and

FIG. 10 is a block diagram showing a hardware configuration example of an information processing device according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description is given in the following order.

### 1. System Configuration

### 2. Functional Configuration

3. Score for each Position in Content

### 4. Propagation of Feedback

### 5. Output of Result

### 6. Example of Data

### 7. Example of Processing Flow

### 8. Use Case

### 9. Hardware Configuration

### 10. Supplement

1. System Configuration

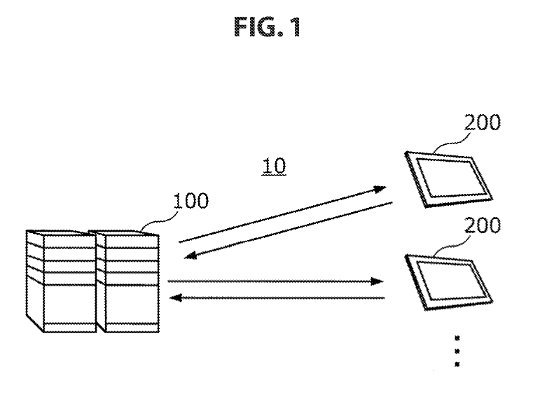

FIG. 1 is a diagram showing a system configuration according to an embodiment of the present disclosure. With reference to FIG. 1, a system 10 includes a server 100 and a terminal device (client) 200. The server 100 connects with the terminal device 200 via a network.

The server 100 includes one or plurality of server devices. The server device may be realized by a hardware configuration of an information processing device as described later. The server 100 provides the plurality of terminal devices 200 with services. More specifically, the server 100 transmits information to a terminal device 200 in response to a request received from the terminal device 200. In addition, the server 100 collects an activity log of a user for content, the activity log having been acquired by the terminal device 200. The collected activity log is used for generating the information to be transmitted from the server 100. Note that, a specific example of the activity log collection and the information generation in the server 100 is described later.

The terminal device 200 may be a tablet terminal, a smartphone, a variety of personal computers, televisions, media players, or game consoles, for example. The terminal device 200 may also be realized by the hardware configuration of the information processing device as described later. The terminal device 200 transmits a request to the server 100, and receives information transmitted from the server 100 in response to the request. The received information may be information on a ranking of content or information on recommendation of the content, for example.

Aside from the information received from the server 100, the terminal device 200 is capable of providing a user with content. For example, the terminal device 200 includes an input device and an output device, and provides the user with the content via a display, a speaker, or the like included in the output device. In addition, the terminal device 200 acquires a comment, rating or the like for content input by a user via a touchscreen, a keyboard, or the like included in the input device. The terminal device 200 transmits the input comment, the input rating or the like to another server that is an original transmission destination, and the terminal device 200 also transmits the input comment, the input rating or the like as an activity log of the user for the content to the server 100. In addition, the terminal device 200 may also transmit a history of the user for content reproduction or content purchase as an activity log to the server 100.

2. Functional Configuration

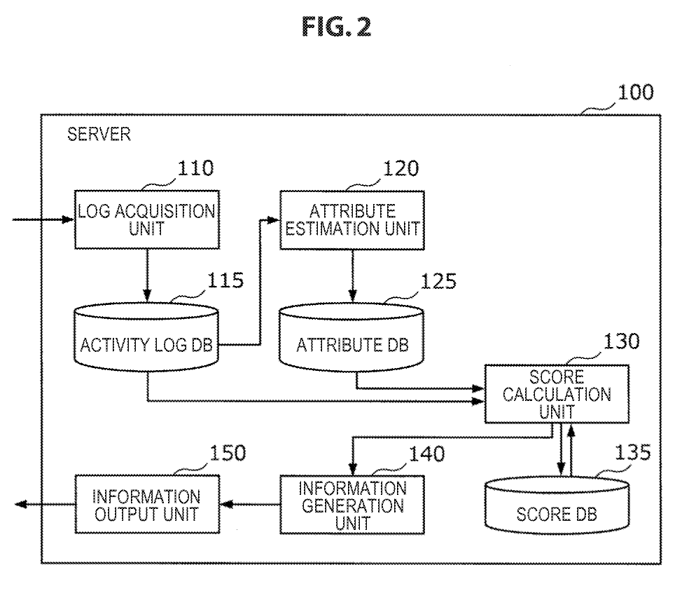

FIG. 2 is a block diagram schematically showing functional configurations of a server according to an embodiment of the present disclosure. With reference to FIG. 2, the server 100 includes a log acquisition unit 110, an attribute estimation unit 120, a score calculation unit 130, an information generation unit 140, and an information output unit 150. Such functional configurations may be achieved by a processor of the server device included in the server 100, the processor operating in accordance with a program stored in memory or in storage. In addition, the server 100 further includes an activity log DB 115, an attribute DB 125, and a score DB 135. Such DBs are achieved by the memory or the storage of the server device included in the server 100, for example. Hereinafter, such functional configurations are explained.

The log acquisition unit 110 acquires an activity log of a user for content, the activity log having been acquired by the terminal device 200. For example, the activity log includes a purchase log of the user for the content, a rating log of the user for the content, a view log of the user for the content, or an access log of the user for the content via a plurality of media. The log acquisition unit 110 stores the acquired activity log in the activity log DB 115. As described later, information generated by the information generation unit 140 is not personalized for each user in the present embodiment. Accordingly, the activity log is used with being anonymized finally. Note that, so that the attribute estimation unit 120 estimates an attribute or so that the score calculation unit 130 associates an activity log with the attribute, data to be stored in the activity log DB 115 may be associated with an ID of a user who performs activity in the terminal device 200.

The attribute estimation unit 120 estimates an attribute of the user for the content on the basis of the activity log. For example, the attribute estimation unit 120 estimates an attribute indicating whether the user has purchased the content in a case where the activity log includes the purchase log of the user for the content. In this case, the attribute estimation unit 120 may classify the user as a “user who has purchased the content” or as a “user who has not purchased the content”. In addition, for example, the attribute estimation unit 120 estimates an attribute indicating whether or not the user has viewed the content or an attribute indicating which part of the content the user has viewed, in a case where the activity log includes the view log of the user for the content. In this case, the attribute estimation unit 120 may classify the user as a “user who has viewed the whole content” or as a “user who has viewed only a part of the content” or as a “user who has not viewed the content”.

In addition, for example, if content accessed by the user via the plurality of media belongs to a common genre in a case where the activity log includes the access log of the user for the content via the plurality of media, the attribute estimation unit 120 estimates an attribute indicating that the user is familiar with the genre. The attribute estimation unit 120 stores the estimated attribute of the user in the attribute DB 125. For a reason similar to the case of the activity log, data to be stored in the attribute DB 125 may also be associated with an ID of a user who performs activity in the terminal device 200.

The score calculation unit 130 calculates a score on the content on the basis of the activity log and the attribute. For example, the score calculation unit 130 first calculates a score on the content for each user on the basis of the activity log, metadata of the content, and the like. The activity log used for this calculation is the purchase log of the user for the content, or the rating log of the user for the content, for example. Since such score calculation method has been widely known already, a detailed explanation is omitted. A score on the content can be calculated by simply adding the scores calculated in such a way for each user. However, as described above, when all feedback of the users are treated equally, the calculated score may be different from the desired score.

Accordingly, in the present embodiment, an attribute of each user for content estimated by the attribute estimation unit 120 is reflected when the score calculation unit 130 calculates a score on the content on the basis of an activity log. For example, the score calculation unit 130 may raise a contribution degree to the score of the rating log of a user for which the attribute indicates that the user has purchased the content. In this case, both a user who has purchased the content and a user who has not purchased the content can input rating. However, the rating input by the user who has purchased the content has a large contribution degree to the score. In addition, for example, the score calculation unit 130 may raise a contribution degree to a score on a rating log of a user for which the attribute indicates that the user has viewed more parts of the content. In this case, rating input by a user who has viewed even a part of the content has a larger contribution degree to the score than rating input by a user who has viewed no part of the content, for example. In addition, rating input by a user who has viewed the whole content has a larger contribution degree to the score than rating input by a user who has viewed only a part of the content. Moreover, for example, the score calculation unit 130 may raise a contribution degree to the score on the rating log of a user for which the estimated attribute indicates that the user is familiar with the genre of the content. In this case, rating input by a user who is familiar with the genre of the content has a larger contribution degree to the score than rating input by a user who is not so much familiar with the genre of the content.

By the above-described process performed by the score calculation unit 130, an attribute of a user for content is more considered when a score on the content is calculated. Accordingly, the score rated more in line with an actual condition can be calculated.

The score calculation unit 130 stores the calculated score on the content in the score DB 135. Subsequently, the score calculation unit 130 provides the information generation unit 140 with a newly calculated score or the score that has been already calculated and stored in the score DB 135. Note that, in the shown example, the score calculation unit 130 newly calculates a score on the basis of an activity log stored in the activity log DB 115 and an attribute stored in the attribute DB 125, and then the score calculation unit 130 stores the newly calculated score in the score DB 135. However, the embodiment of the present disclosure is not limited to such example. For example, the score calculation unit 130 may recalculate, on the basis of an attribute stored in the attribute DB 125, a score that has been already calculated on the basis of an activity log and stored in the score DB 135. Subsequently, the score calculation unit 130 stores a result of the recalculation in the score DB 135 again, or provides the information generation unit 140 with the result of the recalculation. Alternatively, according to another example, an activity log used for calculating a score may be different from an activity log used for estimating an attribute. In this case, the score calculation unit 130 recalculates a score on the basis of an attribute of each user for content estimated on the basis of a second activity log different from a first activity log, the score having been calculated on the basis of the first activity log.

Here, a score that is stored in the score DB 135 by the score calculation unit 130 or a score that is provided to the information generation unit 140 by the score calculation unit 130 does not have to be associated with an ID of a user who has provided an activity log used for calculating a score or estimating an attribute. That is, the score on the content to be provided to the information generation unit 140 or to be read from the score DB 135 and used by an external device may be anonymized in the present embodiment.

On the other hand, the score may be associated with information on an attribute of a user. For example, the score calculation unit 130 calculates a score by integrating scores of a plurality of users having different attributes in accordance with each of the attributes. More specifically, as described in the above example, the score calculation unit 130 may weight a score of each user for content in accordance with an attribute of each user for the content, and may add each score. In this case, since each score on the content is integrated beyond attributes, scores and attributes are not associated with each other. Alternatively, the score calculation unit 130 may calculate a score by individually adding scores of a plurality of users having different attributes in accordance with each of the attributes. In this case, a plurality of scores for each attribute of a user are calculated for each content. Accordingly, the score calculation unit 130 associates a score with an attribute of a user, and then stores the score in the score DB 135 or provides the information generation unit 140 with the score.

The information generation unit 140 generates information based on the score calculated by the score calculation unit 130, and the information output unit 150 outputs the information generated by the information generation unit 140. For example, the information generation unit 140 may generate ranking information based on the score. In this case, the information generation unit 140 may generate a single ranking information item based on an integrated score in consideration of an attribute of each user, or may generate a plurality of ranking information items for each attribute of a user. Alternatively, for example, the information generation unit 140 may generate content recommendation information based on the score. In this case, the information generation unit 140 may generate a single content recommendation information item based on an integrated score in consideration of an attribute of each user, or may generate a plurality of content recommendation information items for each attribute of a user.

In a case where the plurality of ranking information items or content recommendation items are generated for each attribute of a user in the above-described example, the information output unit 150 may output information based on one or plurality of scores on one or plurality of attributes selected from among the different attributes in response to an operation by a user who refers to information. In this case, a selector for attributes may be provided in a user interface (UI) for providing a user with information, for example. The selector may be a drop-down list, radio buttons, or the like in a case of screen display. More specifically, for example, in a case where attributes including a beginner (not so much familiar with a certain genre), a middle-level user (moderately familiar with the certain genre), and an advanced user (very much familiar with the certain genre) are set for the certain genre (any genre of any content, such as a live soccer TV, a thriller novel, or progressive rock), a user who refers to information can select which of a “ranking of beginners”, a “ranking of middle-level users, and a “ranking of advanced users” is displayed in response to an operation performed by the user.

Alternatively, the information output unit 150 may output information based on a score of an attribute automatically selected from among the different attributes on the basis of an attribute of a user who refers to information. In this case, for example, the information output unit 150 automatically selects information complying with an attribute of a user from the plurality of ranking information items or content recommendation items, on the basis of an attribute of a user who refers to information, the attribute having been estimated on the basis of an activity log provided in the past by the user (or the attribute may be an attribute that has been estimated by functions of the log acquisition unit 110 and the attribute estimation unit 120). More specifically, for example, in a case where attributes including a beginner, a middle-level user, and an advanced user are set for a certain genre, “content recommendation to beginners” is provided to a user who has been estimated to be the beginner on the basis of an activity log, and “content recommendation to middle-level users” is provided to a user who has been estimated to be the middle-level user in a similar way, and “content recommendation to advanced users” is provided to a user who has been estimated to be the advanced user. In addition, after being provided with the information in such a way, the user who refers to the information may be capable of referring to information generated on the basis of a score of a user having another attribute, by using the selector for attributes included in the UI, for example.

3. Score for Each Position in Content

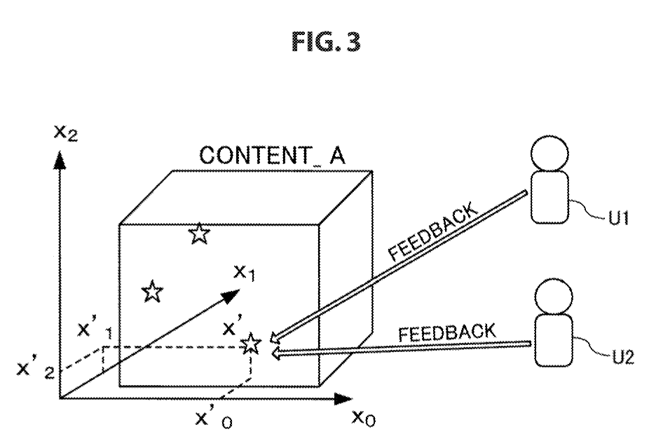

FIG. 3 is a diagram illustrating calculation of a score for each temporal position of content according to an embodiment of the present disclosure. FIG. 3 shows three axes x₀, x₁, and x₂ that are set for content A and rating (feedback) that users U1 and U2 have input as to a position x′=(x′₀, x′₁, x′₂) in the content A.

Here, the axes x₀, x₁, and x₂ are set for indicating a position in the content A. For example, in a case where the content A is video content, the axis x₀ represents a temporal position (timestamp) of the content A, and the axes x₁ and x₂ represent positions in images at respective time points. In this case, the log acquisition unit 110 acquires activity logs (rating logs for the content A in this case) of the users U1 and U2 input as to the position x′=(x′₀, x′₁, x′₂) for each temporal position of the content A, and acquires the activity logs for each position in the images included in the content A.

Also in this case, the score calculation unit 130 may calculate a score for each temporal position of the content A or for each position in the images included in the content A, on the basis of information in the activity log DB 115, the information having been accumulated for each temporal position of the content A and for each position in the images included in the content A. In this case, the information generation unit 140 may also generate information for each position in the content. Alternatively, it is also possible for the score calculation unit 130 to integrate activity logs acquired for each position in variety of images at many temporal positions in the content A and then to calculate a score on the whole content A. In a case where the score on the whole content A is calculated, the score calculation unit 130 may calculate the score by the following Expression 1.

$$Score = {\sum }_{axis} {\sum }_{user} {w}_{user} \cdot {F}_{user} ( {x}_{axis}^{′} ) \qquad ( Expression 1 )$$

In the above Expression 1, Score represents a score on the whole content A, Σ(axis) represents a sum of scores calculated for respective positions in the content A that are indicated by the axes x₀, x₁, and x₂, Σ(user) represents a sum of scores on all users each for which a rating log for the content A has been acquired, wᵤₛₑᵣ represents a weight used for calculating a score from an attribute of each of the users, and Fᵤₛₑᵣ (X′ₐₓᵢₛ) represents a rating value (feedback score) that each of the users has input as to the position x′ in the content A.

For example, in the present embodiment, it can be determined whether or not each user has actually purchased the content A by using a purchase log for the content acquired by the log acquisition unit 110. Accordingly, in a case where each user has rated (the position x′ in) the content A, rating input by a user who has purchased the content A contributes greatly to a score used for rating the content A. For example, the rating input by the user may be acquired from a review of the content A or a rating input about the content A that are other kinds of activity logs acquired by the log acquisition unit 110. By combining such information, feedback information from a user who has highly rated the content A can be collected from among the users who have actually purchased the content A, for example. When a highly rated part (for example, temporal section) in the content A is extracted on the basis of such information, highly reliable information indicating the “best part” of the content A can be obtained. On the other hand, it is also possible to collect feedback information from a user who has lowly rated the content A from among the users who have actually purchased the content A. When a lowly rated part (for example, temporal section) in the content A is extracted on the basis of such information, highly reliable information indicating a “boring part” of the content A can be obtained. Accordingly, for example, it is possible to recognize which part of an electronic book a user has felt to be boring, or which scene in a movie a user has felt to be boring, with high reliability.

4. Propagation of Feedback

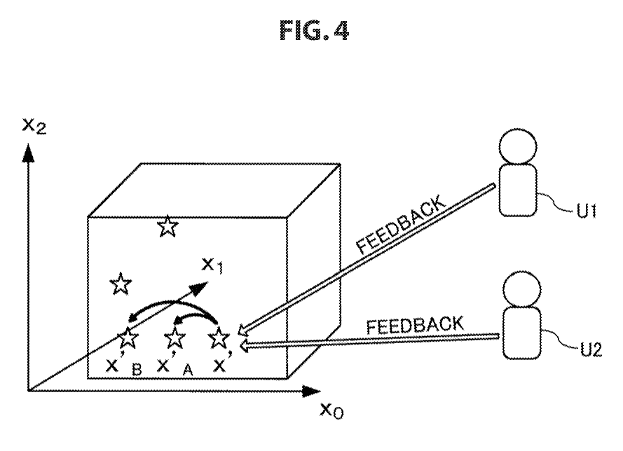

FIG. 4 is a diagram illustrating propagation of feedback according to an embodiment of the present disclosure. With reference to FIG. 4, feedback (rating by the users U1 and U2) input as to the position x′ in the content A in a way similar to the example in FIG. 3 propagates to different positions x′_{A} and x′_{B} in the same content A.

Here, when the positions x′_{A} and x′_{B} in the content A and the position x′ to which the feedback have been input are compared, the positions x′_{A} and x′_{B} and the position x′ have a certain common attribute (for example, a cast in scenes) indicated by metadata, for example. In such a case, the log acquisition unit 110 propagates the feedback input as to the position x′ to the positions x′_{A} and x′_{B}. Here, a commonality between positions in the content may be determined from the metadata as described above, or may be determined from a characteristic feature of an image or a sound. The determination from the metadata may use collaborative filtering (CF) or content based filtering (CBF), for example.

In a similar way, the log acquisition unit 110 may propagate the feedback input as to the content A to another content (referred to as content B) having an attribute common to the content A. In this case, a contribution degree to a score of the content B serving as a propagation destination of the feedback may be decided in accordance with a similarity between the content A and the content B, the similarity being calculated by the CF or the CBF, for example. That is, for example, in a case where the similarity between the content A and the content B is high, the contribution degree of the feedback input as to the content A to the score of the content B becomes high. On the other hand, in a case where the similarity between the content A and the content B is low, the contribution degree of the feedback input as to the content A to the score of the content B becomes low, or the feedback input as to the content A do not contribute to the score of the content B.

In the case where the propagation of the feedback occurs, the server 100 may include a similarity DB in addition to the above described activity log DB 115, attribute DB 125, and score DB 135, the similarity DB storing data of a similarity between content items (or between scenes in a content item). By propagating the feedback as described in the above example, it is possible to generate information such as a ranking or content recommendation based on the feedback even if only a few users access to content and enough feedback to the content or details of the content are not collected since a service has just been started.

5. Output of Result

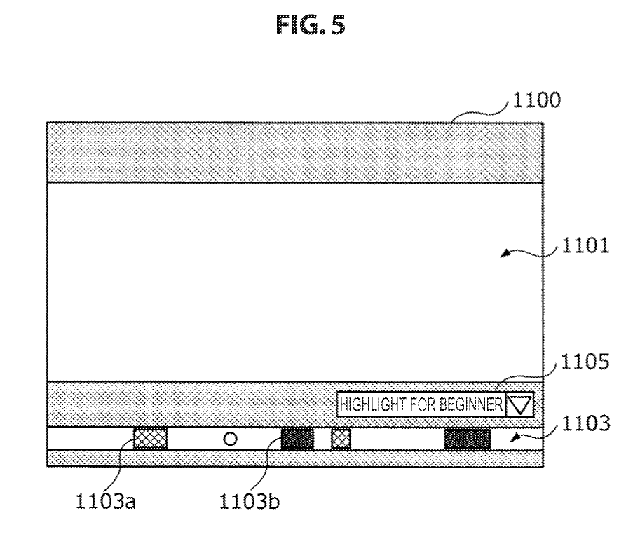

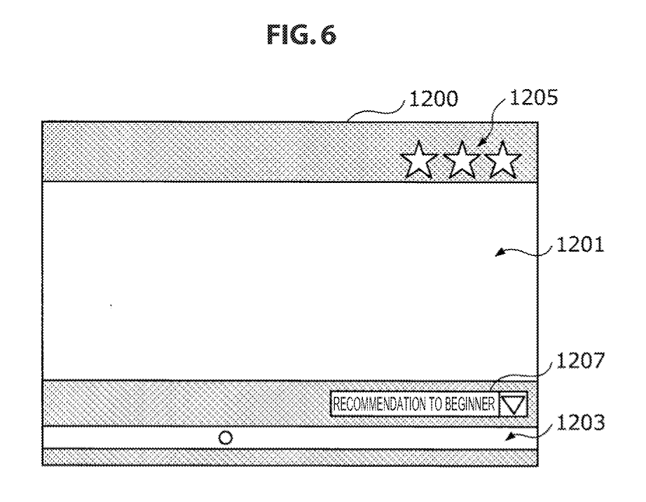

FIGS. 5 and 6 are diagrams showing examples of output of results according to an embodiment of the present disclosure. In a screen 1100 shown in FIG. 5, a seek bar 1103 that is displayed with a content image 1101 displays regions 1103a and 1103b which are colored on the basis of scores calculated for respective positions in content. The regions 1103a and 1103b may indicate parts to which feedback by another user gives a high rating from among this content, for example. Colors of the regions 1103a and 1103b may change in accordance with scores based on ratings, for example. In this case, it can be said that the colors of the regions 1103a and 1103b represent rankings such as preferences or attention degrees in the content. Alternatively, in a case where feedback from another user is calculated for each attribute of the another user, for example, it may be possible to switch the display of the seek bar 1103 between “highlight for beginner”, “highlight for middle-level user”, and “highlight for advanced user” by using an attribute selector 1105.

In a screen 1200 shown in FIG. 6, an effect 1205 is displayed with a content image 1201 and a seek bar 1203, the effect 1205 indicating a score calculated for whole content. For example, as the shown example, the number of stars in the effect 1205 represents a score calculated for content. In this case, it can be said that the effect 1205 recommends the content to a user by displaying many stars. In a way similar to the above example, it may be possible to change the display of the effect 1205 to be based on a score of a user having another attribute, by using an attribute selector 1207. In this case, the number of the starts in the effect 1205 is changed in accordance with the selected attribute, for example. Note that, an effect similar to the shown example is not limited to the video content. For example, the effect may be displayed in a screen of an electronic book or a game.

6. Example of Data

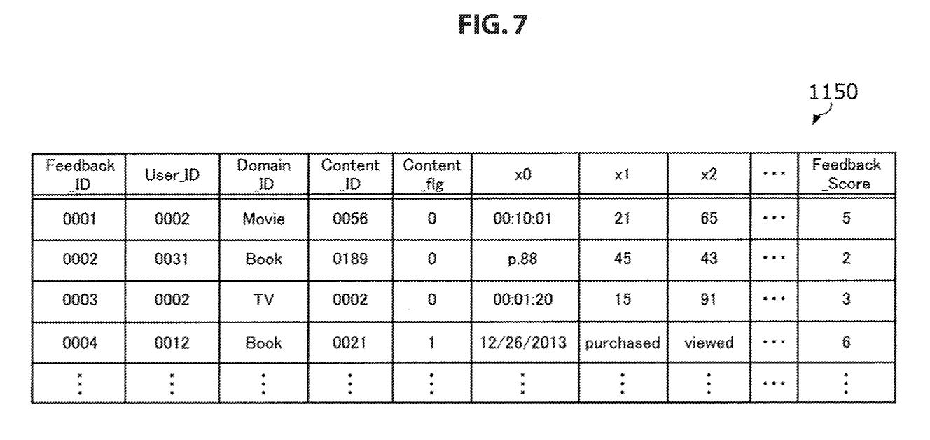

FIG. 7 is a diagram showing an example of an activity log DB according to an embodiment of the present disclosure. FIG. 7 displays an example of data stored in the activity log DB 115 according to an embodiment of the present disclosure. In the shown example, data 1150 includes items of feedback ID, user ID, domain ID, content ID, content flag, x0, x1, x2, and feedback score.

The feedback ID is an ID for identifying each record in the data 1150. The user ID is an ID for identifying a user who inputs feedback in the terminal device 200. The domain ID is an ID for identifying a domain of content serving as a feedback target. The domain may be said to be a medium. For example, in a case where the attribute estimation unit 120 estimates an attribute which indicates that a user is familiar with a common genre, the user being accessing to content in the common genre via a plurality of media, the attribute estimation unit 120 may refer to the domain ID and determine an attribute of the user.

The content ID is an ID for identifying content serving as a feedback target. The content flag is a flag indicating whether the feedback targets whole content or a position in the content. In the shown example, the feedback targets a position in the content in a case where the content flag is “0”, and the feedback targets the whole content in a case where the content flag is “1”. Meanings of the following items x0, x1, and x2 are different for each content flag.

x0 indicates a position in the content serving as the feedback target in a case where the content flag is “0” and the feedback targets the position in the content. For example, feedback to content (movie or TV program) whose domain ID is “Movie” or “TV” represents the target position by using a timestamp such as “00:10:01”. Alternatively, feedback to content (electronic book) whose domain ID is “Book” represents the target position by using the number of pages such as “p. 88”. In such examples, x1 may indicate a display time length of the target position, and x2 may indicate the number of times for displaying the target position.

On the other hand, x0 indicates day and time when the feedback is performed, in a case where the content flag is “1” and the feedback targets the whole content. In addition, in this case, x1 indicates whether the user has purchased the content, and x2 indicates the user has viewed the content. Information recorded as x0, x1, and x2 in the above two examples are used by the attribute estimation unit 120 estimating an attribute of the user, or by the score calculation unit 130 calculating a score, for example. In addition, the data 1150 may include more information such as x3, x4, . . . .

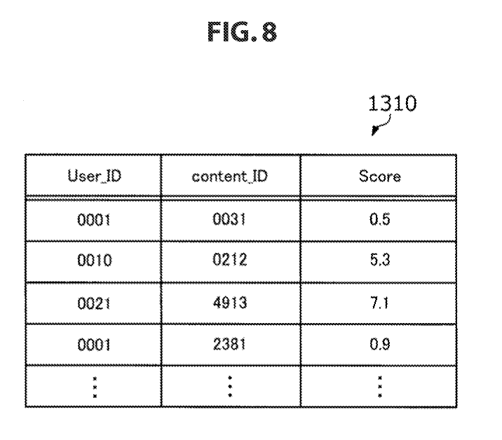

The feedback score is a score on content indicated by each feedback. For example, the score calculation unit 130 first calculates a score on the content for each user on the basis of the feedback score, and then recalculate the score on the basis of an attribute of each user. Hereinafter, with reference to FIG. 8, an example of scores on content for respective users is explained.

FIG. 8 is a diagram showing an example of scores on content for respective users according to an embodiment of the present disclosure. In the example shown in FIG. 8, data 1310 includes items of user ID, content ID, and score.

The user ID and the content ID are IDs for identifying content and users in a way similar to the example in FIG. 7. The score is calculated on the basis of the feedback from each user to content. What the score means differs in accordance with a kind of the feedback score. For example, when the feedback score is a score generated from a rating log by using the CF, scores in the data 1310 may indicate preferences of the users for the content. Hereinafter, an example of processing using data generated in such a way is further explained.

7. Example of Processing Flow

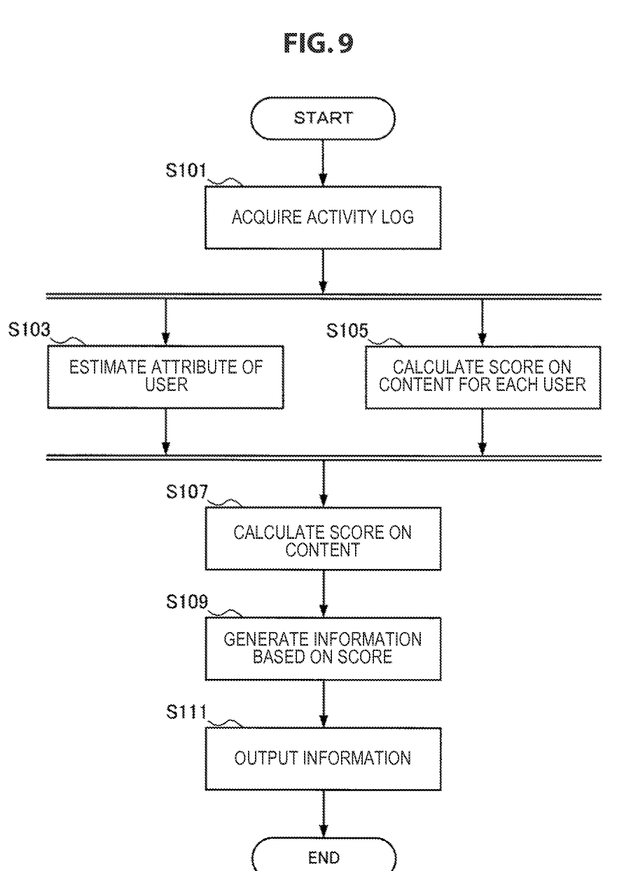

FIG. 9 is a flowchart showing an example of processing according to an embodiment of the present disclosure. With reference to FIG. 9, the log acquisition unit 110 first acquires an activity log of a user for content (S101). Next, the attribute estimation unit 120 estimates an attribute of the user on the basis of the activity log (S103). In addition, the score calculation unit 130 calculates a score on the content for each user on the basis of the activity log acquired by the log acquisition unit 110 or another acquired activity log (S105).

The score calculation unit 103 calculates a score on the content after receiving results of S103 and S105 (S107). For example, the score calculation unit 130 calculates a score on content by weighting the scores on the content for each user calculated in S105 in accordance with the attribute of each user estimated in S103, and adding the scores. Alternatively, the score calculation unit 130 calculates a score on content for each attribute by individually adding the scores on the content for each user calculated in S105 in accordance with the attribute for each user.

Next, the information generation unit 140 generates information based on the score calculated in S107 (S109). The information to be generated may be information on a ranking or content recommendation using the scores. Subsequently, the information output unit 150 outputs the generated information (S111).

8. Use Case

Next, a more specific example of a use case of a technology relating to an embodiment of the present disclosure is explained.

### First Example

First, an example of a case of calculating a score on content directly from an activity log of a user is explained. In this case, the activity log to be used may include a log (purchase log) indicating when and who has bought what, a log (rating log) indicating how much, when, and who has rated what, and a log (view log) indicating how long, when, and who has viewed what. In this example, a user whose feedback is strengthened (contribution degree to a score on content such as the rating log is strengthened) is a user who has bought the content, who has viewed many parts of the content, and who has highly rated the content.

The score in the above example may be calculated by adding a score based on the purchase log, a score based on the rating log, and a score based on the view log, for example. For example, the purchase score may be 0 (not purchased) or 1 (purchased), the rating score may be 0 (lowest rating) to 1 (highest rating), and the view score may be 0 (never viewed) to 1 (viewed whole content).

### Second Example

Next, an example of a case of calculating a score using the CF when a direct activity log of a user for the target content does not exist is explained. In this case, a score is calculated on the basis of the purchase log, the rating log, and the view log in a way similar to the first example. In this example, even if the direct activity log for the content does not exist, it is possible to estimate a preference of the user for the content on a premise that it is highly possible for users having similar behavioral characteristics to also have similar preference characteristics. More specifically, for example, a matrix indicating a relation between users and contents is generated, and relations between the contents are scored on the basis of co-occurrence relations between the purchase log, the rating log, and the view log for the content. Subsequently, a score of a user for the intended content is calculated on the basis of content in which the purchase log, the rating log, and the view log for the target user are stored, and scores on the relation between the contents. Note that, weights set for the purchase log, the rating log, and the view log used for calculating scores are appropriately set so as to satisfy a condition that “feedback from a user who has purchased the content, who has viewed many parts of the content, and who has highly rated the content is strengthened.”

### Third Example

Next, an example of personalization of result output is explained. As described above, a result to be output based on a score on content is not personalized for each user in the present embodiment. However, the result to be output is personalized for a user group (a plurality of users) having a certain attribute, for example.

For example, when a score on content is calculated, feedback from a user group may be strengthened, the user group been estimated to be close to a recipient of information on the basis of the activity log or the like. For example, a user who often watches soccer games on a TV may be provided with information based on a score calculated by increasing a contribution degree of feedback from a user who also often watches the soccer games in a similar way. In addition, when the score on the content is calculated, information at a standpoint that a user selects from information generated in accordance with various standpoints (for example, a plurality of rankings) may be provided. For example, it is possible for a user who does not often watch soccer games on a TV to refer to information based on a score calculated by increasing a contribution degree of feedback from a user who often watches the soccer games by an operation using an attribute selector, for example. In this case, it is possible for even a beginner to perform highlight view through advanced users' eyes. In addition, for example, a suggestion for improving a configuration of a book can be obtained by comparing parts where feedback are made by users who has bought, read, and lowly rated the book and parts where feedback are made by users who has bought, read, and highly rated the book.

9. Hardware Configuration

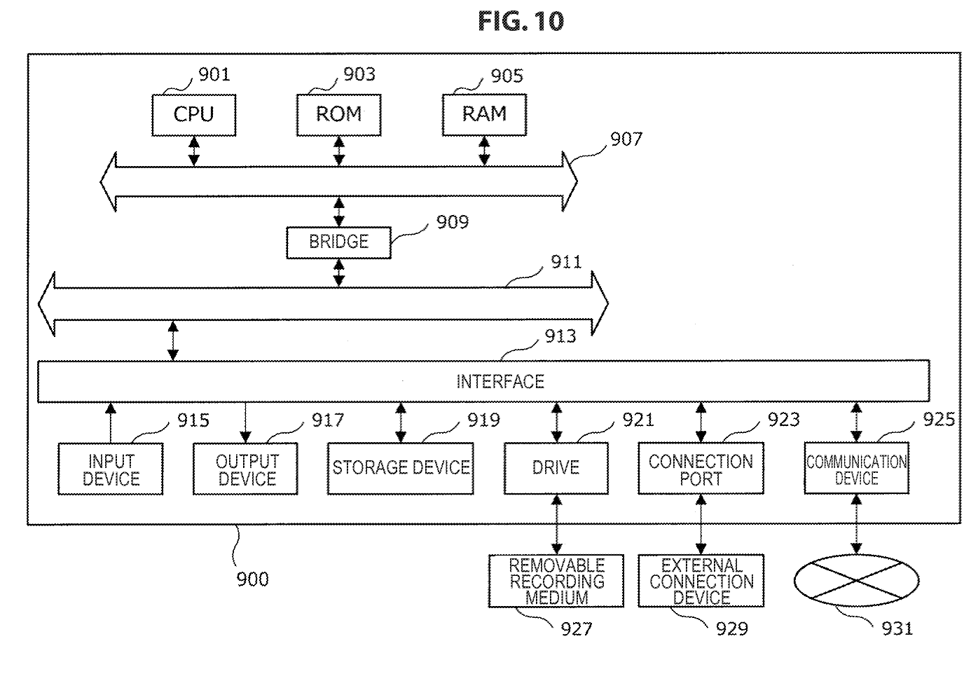

Next, a hardware configuration of an information processing device according to an embodiment of the present disclosure will be described with reference to FIG. 10. FIG. 10 is a block diagram illustrating a hardware configuration example of the information processing device according to an embodiment of the present disclosure. An information processing device 900 shown in FIG. 10 may realize, for example, the server device in the above-described embodiment.

The information processing device 900 includes a central processing unit (CPU) 901, read-only memory (ROM) 903, and random access memory (RAM) 905. The information processing device 900 may also include a host bus 907, a bridge 909, an external bus 911, an interface 913, an input device 915, an output device 917, a storage device 919, a drive 921, a connection port 923, and a communication device 925. The information processing device 900 may include a processing circuit such as a digital signal processor (DSP) or an application specific integrated circuit (ASIC), alternatively or in addition to the CPU 901.

The CPU 901 functions as an arithmetic processor and a controller and controls the overall operation or a part thereof within the information processing device 900 in accordance with various kinds of programs recorded in the ROM 903, the RAM 905, the storage device 919, or a removable recording medium 927. The ROM 903 stores, for example, arithmetic parameters and programs to be used by the CPU 901. The RAM 905 temporarily stores, for example, a program executed by the CPU 901 as well as parameters that appropriately change during the execution of the program. The CPU 901, the ROM 903, and the RAM 905 are connected to each other via the host bus 907, which is constituted of an internal bus such as a CPU bus. Furthermore, the host bus 907 is connected to the external bus 911, such as a peripheral component interconnect/interface (PCI), via the bridge 909.

The input device 915 is a user-operable device, such as a mouse, a keyboard, a touchscreen, a button, a switch, and a lever. The input device 915 may be, for example, a remote control device that uses infrared or other electric waves, or an external connection device 929 such as a portable telephone that complies with operation of the information processing device 900. The input device 915 includes an input control circuit that generates an input signal based on information input by the user and that outputs the input signal to the CPU 901. The user may operate this input device 915 so as to input various kinds of data to the information processing device 900 or to command the information processing device 900 to perform processing.

The output device 917 is constituted by a device that is capable of visually or aurally notifying the user of acquired information. The output device 917 may be, for example, a display device, such as a liquid crystal display (LCD), a plasma display panel (PDP), or an organic electroluminescence (EL) display, an audio output device, such as a speaker and a headphone, and a printer. The output device 917 outputs an obtained result of processing performed by the information processing device 900 in the form of video such as text or an image and also in the form of audio such as voice or sound.

The storage device 919 is a data storage device formed as an example of a storage unit of the information processing device 900. The storage device 919 is constituted of, for example, a magnetic storage device, such as a hard disk drive (HDD), a semiconductor storage device, an optical storage device, or a magneto-optical storage device. This storage device 919 stores, for example, various kinds of data and programs executed by the CPU 901, as well as various kinds of data acquired from an external source.

The drive 921 is a reader-writer for the removable recording medium 927, such as a magnetic disk, an optical disk, a magneto-optical disk, or a semiconductor memory, and is built inside or externally connected to the information processing device 900. The drive 921 reads information recorded in the mounted removable recording medium 927 and outputs the information to the RAM 905. Furthermore, the drive 921 writes a record into the mounted removable recording medium 927.

The connection port 923 is a port used for directly connecting a device to the information processing device 900. The connection port 923 may be, for example, a universal serial bus (USB) port, an IEEE1394 port, or a small computer system interface (SCSI) port. Alternatively, the connection port 923 may be, for example, an RS-232C port, an optical audio terminal, or a high-definition multimedia interface (HDMI (registered trademark)) port. By connecting the external connection device 929 to the connection port 923, various kinds of data are exchangeable between the information processing device 900 and the external connection device 929.

The communication device 925 is, for example, a communication interface constituted of a communication device for connecting to a communication network 931. The communication device 925 may be, for example, a communication card for a wired or wireless local area network (LAN), Bluetooth (registered trademark), or a wireless USB (WUSB). Alternatively, the communication device 925 may be, for example, an optical communication router, an asymmetric digital subscriber line (ADSL) router, or various types of communication modems. For example, the communication device 925 exchanges a signal between the Internet and another communication device by using a predetermined protocol such as TCP/IP. The communication network 931 connected to the communication device 925 is a network connected in a wired or wireless manner and is, for example, the Internet, a domestic LAN, infrared communication, a radio-wave communication, or satellite communication.

An example of the hardware configuration of the information processing device 900 has been described above. Each of the components described above may be configured by using a general purpose component or may be configured by hardware specialized for the function of the component. The above configuration may be appropriately modified in accordance with the technological level at the time of implementation.

10. Supplement

The embodiments of the present disclosure may include, for example, the above-described information processing device, the above-described system, an information processing method executed by the information processing device or the system, a program for causing the information processing device to exhibits its function, and a non-transitory tangible medium having the program stored therein.

Although preferred embodiments of the present disclosure have been described in detail above with reference to the appended drawings, the technical scope of the embodiments of the present disclosure is not limited to the above example. It is obvious to those with a general knowledge of the technical field of the embodiments of the present disclosure that various modifications and alterations may occur within the technical scope defined in the claims, and that these modifications and alterations are encompassed within the technical scope of the embodiments of the present disclosure.

Furthermore, the advantages discussed in this specification are only intended for illustrative and exemplary purposes and are not limitative. In other words, in addition to or in place of the above-described advantages, the technology according to the embodiments of the present disclosure may exhibit other advantages that are obvious to a skilled person from the specification.

Additionally, the present technology may also be configured as below:

(1) An information processing device including:

a log acquisition unit configured to acquire an activity log of a user for content;

an attribute estimation unit configured to estimate an attribute of the user for the content on the basis of the activity log; and

a score calculation unit configured to calculate a score on the content on the basis of the activity log and the attribute.

(2) The information processing device according to (1),

wherein the activity log includes a purchase log of the user for the content, and

wherein the attribute estimation unit estimates the attribute that indicates whether or not the user has purchased the content.

(3) The information processing device according to (2),

wherein the activity log further includes a rating log of the user for the content, and

wherein the score calculation unit raises a contribution degree of the rating log of a user who has purchased the content to the score.

(4) The information processing device according to any one of (1) to (3),

wherein the activity log includes a view log of the user for the content, and

wherein the attribute estimation unit estimates the attribute that indicates whether or not the user has viewed the content, or which part of the content the user has viewed.

(5) The information processing device according to (4),

wherein the activity log further includes a rating log of the user for the content, and

wherein the score calculation unit raises a contribution degree of the rating log of a user who has viewed the content or a user who has viewed more parts of the content to the score.

(6) The information processing device according to any one of (1) to (5),

wherein the activity log includes an access log of the user for the content via a plurality of media, and

wherein, in a case where content accessed by the user via the plurality of media belongs to a common genre, the attribute estimation unit estimates the attribute which indicates that the user is familiar with the genre.

(7) The information processing device according to (6),

wherein the activity log further includes a rating log of the user for the content, and

wherein the score calculation unit raises a contribution degree of the rating log of a user who has been estimated to be familiar with the genre to the score.

(8) The information processing device according to any one of (1) to (7),

wherein the score calculation unit calculates the score by integrating scores of a plurality of users having different attributes in accordance with each of the attributes.

(9) The information processing device according to any one of (1) to (7),

wherein the score calculation unit calculates the score by adding scores of a plurality of users having different attributes individually for each of the attributes.

(10) The information processing device according to (9), further including:

an information generation unit configured to generate information based on the score; and

an information output unit configured to output information based on the score of an attribute selected from among the different attributes by an operation of a user who refers to information.

(11) The information processing device according to (9), further including:

an information generation unit configured to generate information based on the score; and

an information output unit configured to output information based on the score of an attribute automatically selected from among the different attributes on the basis of an attribute of a user who refers to information.

(12) The information processing device according to any one of (1) to (11),

wherein the activity log includes a first activity log and a second activity log, and

wherein the score calculation unit recalculates a score on the basis of the attribute estimated on the basis of the second activity log, the score having been calculated on the basis of the first activity log.

(13) The information processing device according to any one of (1) to (12), further including:

an information generation unit configured to generate ranking information based on the score.

(14) The information processing device according to any one of (1) to (13), further including:

an information generation unit configured to generate content recommendation information based on the score.

(15) The information processing device according to (1) to (14),

wherein the log acquisition unit acquires the activity log for each position in the content, and

wherein the score calculation unit calculates the score for each position in the content.

(16) The information processing device according to (15), further including:

an information generation unit configured to generate information for each position in the content on the basis of the score.

(17) The information processing device according to (15) or (16),

wherein the log acquisition unit propagates the activity log acquired for a first position in the content to a second position in the content, the second position having an attribute common to the first position.

(18) The information processing device according to any one of (1) to (17),

wherein the log acquisition unit propagates the activity log acquired for first content to second content having an attribute common to the first content.

(19) An information processing method including:

acquiring an activity log of a user for content;

estimating an attribute of the user for the content on the basis of the activity log; and

calculating, by a processor, a score on the content on the basis of the activity log and the attribute.

(20) A program for causing a computer to achieve:

a function of acquiring an activity log of a user for content;

a function of estimating an attribute of the user for the content on the basis of the activity log; and

a function of calculating a score on the content on the basis of the activity log and the attribute.

What is claimed is:

1. An information processing device comprising:
a log acquisition unit configured to acquire an activity log of a user for content;
an attribute estimation unit configured to estimate an attribute of the user for the content on the basis of the activity log; and
a score calculation unit configured to calculate a score on the content on the basis of the activity log and the attribute.

2. The information processing device according to claim 1,
wherein the activity log includes a purchase log of the user for the content, and
wherein the attribute estimation unit estimates the attribute that indicates whether or not the user has purchased the content.

3. The information processing device according to claim 2,
wherein the activity log further includes a rating log of the user for the content, and
wherein the score calculation unit raises a contribution degree of the rating log of a user who has purchased the content to the score.

4. The information processing device according to claim 1,
wherein the activity log includes a view log of the user for the content, and
wherein the attribute estimation unit estimates the attribute that indicates whether or not the user has viewed the content, or which part of the content the user has viewed.

5. The information processing device according to claim 4,
wherein the activity log further includes a rating log of the user for the content, and
wherein the score calculation unit raises a contribution degree of the rating log of a user who has viewed the content or a user who has viewed more parts of the content to the score.

6. The information processing device according to claim 1,
wherein the activity log includes an access log of the user for the content via a plurality of media, and
wherein, in a case where content accessed by the user via the plurality of media belongs to a common genre, the attribute estimation unit estimates the attribute which indicates that the user is familiar with the genre.

7. The information processing device according to claim 6,
wherein the activity log further includes a rating log of the user for the content, and
wherein the score calculation unit raises a contribution degree of the rating log of a user who has been estimated to be familiar with the genre to the score.

8. The information processing device according to claim 1,
wherein the score calculation unit calculates the score by integrating scores of a plurality of users having different attributes in accordance with each of the attributes.

9. The information processing device according to claim 1,
wherein the score calculation unit calculates the score by adding scores of a plurality of users having different attributes individually for each of the attributes.

10. The information processing device according to claim 9, further comprising:
an information generation unit configured to generate information based on the score; and
an information output unit configured to output information based on the score of an attribute selected from among the different attributes by an operation of a user who refers to information.

11. The information processing device according to claim 9, further comprising:
an information generation unit configured to generate information based on the score; and
an information output unit configured to output information based on the score of an attribute automatically selected from among the different attributes on the basis of an attribute of a user who refers to information.

12. The information processing device according to claim 1,
wherein the activity log includes a first activity log and a second activity log, and
wherein the score calculation unit recalculates a score on the basis of the attribute estimated on the basis of the second activity log, the score having been calculated on the basis of the first activity log.

13. The information processing device according to claim 1, further comprising:
an information generation unit configured to generate ranking information based on the score.

14. The information processing device according to claim 1, further comprising:
an information generation unit configured to generate content recommendation information based on the score.

15. The information processing device according to claim 1,
wherein the log acquisition unit acquires the activity log for each position in the content, and
wherein the score calculation unit calculates the score for each position in the content.

16. The information processing device according to claim 15, further comprising:
an information generation unit configured to generate information for each position in the content on the basis of the score.

17. The information processing device according to claim 15,
wherein the log acquisition unit propagates the activity log acquired for a first position in the content to a second position in the content, the second position having an attribute common to the first position.

18. The information processing device according to claim 1,
wherein the log acquisition unit propagates the activity log acquired for first content to second content having an attribute common to the first content.

19. An information processing method comprising:
acquiring an activity log of a user for content;
estimating an attribute of the user for the content on the basis of the activity log; and
calculating, by a processor, a score on the content on the basis of the activity log and the attribute.

20. A program for causing a computer to achieve:
a function of acquiring an activity log of a user for content;
a function of estimating an attribute of the user for the content on the basis of the activity log; and
a function of calculating a score on the content on the basis of the activity log and the attribute.
